(19) United States
(12) Patent Application Publication
(10) Pub. No.: US 2012/0156431 A1
(43) Pub. Date: Jun. 21, 2012

(54) MOLDED STRUCTURE

(75) Inventors: Kazuhiko Suto, Chikusei-shi (JP); Yashio Suzuki, Chikusei-shi (JP); Mitsuru Iwai, Chikusei-shi (JP); Kuzuma Kurihara, Tsukaba-shi (JP)

(73) Assignees: National Institute of Advanced Industrial Science and Technology, Chiyoda-ku, Tokyo (JP); Housetec, Inc., Itabashi-ku, Tokyo (JP)

(21) Appl. No.: 13/393,355

(22) PCT Filed: Aug. 27, 2010
(86) PCT No.: PCT/JP2010/064587

§ 371 Date: Feb. 29, 2012

(30) Foreign Application Priority Data
Aug. 31, 2009 (JP) 2009-200464

(51) Int. Cl. B32B 3/00

(52) U.S. Cl. 428/141

(57) ABSTRACT

Provided is a molded structure that demonstrates hydrophilicity with only a fine relief structure on the surface of a resin substrate, has anti-fogging and self-cleaning functions over a long period of time, and maintains transparency in the case the resin substrate is transparent. The molded structure comprises the formation of a fine relief structure on one surface of a resin substrate (1) that continuously prevents a water aggregation phenomenon and demonstrates hydrophilicity for forming a water film, wherein the width or diameter of protrusions (2) of the fine relief structure is equal to or less than the shortest wavelength of visible light, and the center-to-center distance between the protrusions (2) is 200 nm to 400 nm.

### TECHNICAL FIELD

The present invention relates to a molded structure preferably used in window materials or mirrors in, for example, architectural, industrial, automotive or solar cell panel applications, and more particularly, to a molded structure that demonstrates hydrophilicity with only a fine relief structure on the surface of a resin substrate and has antifogging and self-cleaning functions. Moreover, the present invention relates to a molded structure that enhances the sensitivity of antigen-antibody reactions using a DNA array by patterning the resin substrate into hydrophilic portions and water-repellent portions, and reduces pressure loss of fluidic cells.

The present invention claims priority on the basis of Japanese Patent Application No. 2009-200464, filed in Japan on Aug. 31, 2009, the contents of which are incorporated herein by reference.

### BACKGROUND ART

A known example in the prior art of a technology for imparting such as properties as hydrophilicity or antifogging to the surface of a substrate such as plastic or glass consisted of improving wettability of a coated surface to water and prevent the formation of fine water droplets by coating the surface of a target object with an antifogging agent containing a surfactant, for example (see, for example, Patent Document 1).

In addition, a known example of a technology for improving the antifogging properties of a mirror installed in a bathroom consisted of installing a heater behind the mirror and constantly maintaining the surface of the mirror at a temperature equal to or higher than the dew point while heating the mirror with the heater (see, for example, Patent Document 2).

In addition, a known example of a technology for imparting such properties as hydrophilicity, antifogging and self-cleaning consisted of laminating TiO₂, having a photocatalytic function, on the surface of a glass substrate and utilizing the photocatalytic activity of this TiO₂ (see, for example, Patent Document 3).

In addition, a known example of a technology for improving hydrophilicity of the surface of a transparent substrate consisted of imparting hydrophilicity by coating a film onto the substrate and uniformly forming a fine relief surface with an inorganic powder added to the film (see, for example, Patent Document 4).

Moreover, a known example of a technology for maintaining hydrophilicity over a long period of time consisted of forming protrusions and recesses on a silicon plate or glass by photolithography and etching, and imparting hydrophilicity by oxidizing the relief surface (see, for example, Patent Document 5).

In addition, a known example of a technology for forming fine surface recesses and protrusions consists of being able to maintain hydrophilicity due to the presence of fine structures on the nanometer level (see, for example, Patent Document 6). This technology allows the obtaining of an anti-reflective function by inhibiting the effects of diffuse reflection while also allowing the obtaining of super-hydrophilicity according to the selection of the coated substrate by composing a relief structure that is equal to or shorter than the wavelength of visible light.

### PRIOR ART DOCUMENTS

### Patent Documents

Patent Document 1: Japanese Unexamined Patent Application, First Publication No. 2004-263008
Patent Document 2: Japanese Examined Utility Model Application, Second Publication No. H7-42365
Patent Document 3: Japanese Unexamined Patent Application, First Publication No. 2002-201045
Patent Document 4: Japanese Unexamined Patent Application, First Publication No. H11-217560
Patent Document 5: Japanese Unexamined Patent Application, First Publication No. 2001-212966
Patent Document 6: Japanese Unexamined Patent Application, First Publication No. 2007-187868

### DISCLOSURE OF THE INVENTION

### Problems to be Solved by the Invention

However, although the technology described in the aforementioned Patent Document 1 makes it possible to easily make a substrate surface hydrophilic, since this technology involves coating by spraying and the like, it has the problem of lacking sustainability of the imparted hydrophilicity.

On the other hand, although the technology described in Patent Document 2 demonstrates superior antifogging effects for a substrate surface, in addition to being expensive, since it also consumes a large amount of electrical power, its applications are limited.

The technology described in Patent Document 3 has the problem of the presence of limitations on the locations where it can be used due to the need for an adequate amount of ultraviolet light in order to demonstrate the photocatalytic function thereof, thereby making a highly efficient photocatalytic material essential for this technology. In addition, since equipment is also required for replenishing ultraviolet light in order to restore function in the case the photocatalytic function thereof has been lost, this technology also has the problem of being disadvantageous in terms of cost. In addition, since polymeric materials such as resins are decomposed due to the effects of the photocatalytic action thereof, the substrate is limited to the use of inorganic materials.

Although the technology described in Patent Document 4 consists of coating a dispersion containing silicon dioxide fine powder onto soda-lime glass followed by heating and curing, since the conditions for heating and curing consist of heating and curing for 30 minutes at 120° C., there are restrictions placed on substrates that can be used. In addition, conditions for coating onto a transparent resin substrate are not disclosed.

The technology described in Patent Document 5 is premised on a method of producing protrusions and recesses using photolithography and etching. Since this is premised on the use of a silicon substrate for the substrate, this technology cannot be applied to resin substrates.

In the technology described in Patent Document 6, the disclosure relating to hydrophilicity is limited to the substrate being glass in the manner of an automobile windshield or side window, and there is no disclosure regarding the hydrophilicity of a resin substrate such as acrylic resin.

The present invention was proposed in consideration of these circumstances regarding the prior art, and an object thereof is to provide a molded structure that demonstrates hydrophilicity only with a fine relief structure on the surface of a resin substrate, has antifogging and self-cleaning functions that are maintained over a long period of time, and enables transparency to be maintained in the case the resin substrate is transparent.

In addition, an object of the present invention is to provide a molded structure capable of retaining a water film at a desired location by controlling the movement of the water film.

### Means for Solving the Problems

The present invention relates to the following:

(1) a molded structure, comprising the formation of a fine relief structure on one surface of a resin substrate that continuously prevents a water aggregation phenomenon and demonstrates hydrophilicity for forming a water film, wherein the width or diameter of protrusions of the fine relief structure is equal to or less than the shortest wavelength of visible light, and the center-to-center distance between the protrusions is 200 nm to 400 nm;
(2) the molded structure described in (1), wherein the aspect ratio as represented by (height of the protrusions)/(width or diameter of the protrusions) is 0.5 or more;
(3) the molded structure described in (1) or (2), wherein a region A, where the fine relief structure is formed, and a water-repellent region B, where the fine relief structure is not formed, are formed mutually adjacent on the surface of the resin substrate, and the water film migrates from the region B to the region A; and,
(4) the molded structure described in any of (1) to (3), wherein the molded structure is transparent with respect to visible light.

Furthermore, in the present specification and scope of claims for patent, “aspect ratio” refers to the ratio of the height of protrusions to the width or diameter of the bottom (bottom surface) of the protrusions, or in other words, is represented by (protrusion height)/(protrusion width or diameter).

### Effects of the Invention

As has been described above, the present invention makes it possible to realize a molded structure that demonstrates functions such as hydrophilicity, anti-fogging and self-cleaning over a long period of time while maintaining transparency with only a fine relief structure on a resin substrate. Thus, according to the present invention, this type of molded structure can be preferably used in window materials or mirrors and the like in architectural, industrial, automotive and solar cell panel applications.

In addition, by providing a hydrophilic region A and a water-repellent region B on a resin substrate and allowing a water film to migrate from the region B to the region A, if the hydrophilic region A is formed at only the portions of cells while the region B is formed at other portions in a DNA array, antigen-antibody reactions can be detected with high sensitivity while allowing liquid to remain. In addition, in a micron-order fluidic cell such as a micro TAS (micro total analysis system), if the region A is formed at the portion of the flow path where a fluid is desired to flow and the region B is formed at a portion where the fluid is not desired to flow, the fluid is easily allowed to flow only at a desired portion, thereby enabling the flow of fluid under lower pressure.

### BRIEF DESCRIPTION OF THE DRAWINGS

FIG. 1 is a plane view showing one example of a molded structure to which the present invention is applied.

FIG. 2 is a cross-sectional view taken along line X-X′ of the molded structure shown in FIG. 1.

FIG. 3 is a cross-sectional view showing one example of a mold for producing the molded structure shown in FIG. 1.

FIG. 4 is a schematic diagram showing the configuration of one example of a nanoprocessing apparatus for forming the mold shown in FIG. 3.

FIG. 5 is a schematic diagram showing a spot region and a thermal lithography region of laser light focused onto a surface of mold substrate.

FIG. 6 is a plane view showing a state in which a drawing pattern corresponding to recesses is formed in a photoresist on the surface of a mold substrate.

FIG. 7 is a cross-sectional view showing another example of a molded structure to which the present invention is applied.

FIG. 8 is a plane view showing another example of a molded structure to which the present invention is applied.

FIG. 9A indicates measurement data obtained by AFM of a molded structure of Example 1.

FIG. 9B indicates measurement data obtained by AFM of a molded structure of Example 1.

FIG. 9C indicates measurement data obtained by AFM of a molded structure of Example 1.

FIG. 10 is a photograph showing the transparency of a molded structure of Example 1.

FIG. 11 is photograph showing the appearance of a molded structure of Example 2.

FIG. 12 is a photograph showing a state 60 seconds after a molded article of Example 2 has been sprayed with water.

### BEST MODE FOR CARRYING OUT THE INVENTION

The following provides a detailed explanation of the molded structure to which the present invention is applied with reference to the drawings.

Furthermore, in order to facilitate understanding of the characteristics of the present invention, the drawings used in the subsequent explanations may be shown while enlarging those portions that are characteristic for the sake of convenience, and the dimensional ratios of each constituent are not necessarily the same as actual dimensions.

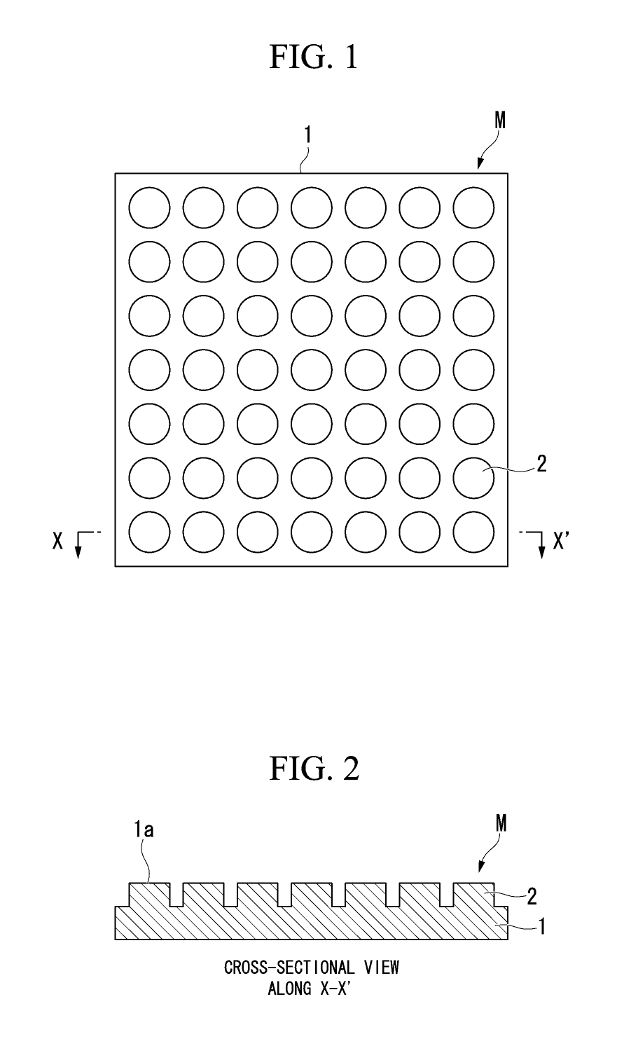

As shown in FIG. 1 and FIG. 2, for example, a molded structure M to which the present invention is applied has a plurality of protrusions 2 arranged at a prescribed pitch in the form of a fine relief surface on one side (surface) la of a plate-like resin substrate 1. The protrusions 2 are characteristically formed in the shape of pillars (cylindrical pillars in FIG. 1 and FIG. 2) in which dimensions such as the width (or diameter) and height thereof is equal to or less than the wavelength of visible light. In addition, the aspect ratio as represented by (height of protrusions 2)/(width or diameter of protrusions 2) is preferably 0.5 or more.

More specifically, a material able to be thermally deformed or a material that is polymerized and cured by an active energy beam can be used for the resin substrate 1, and examples of such materials include thermoplastic resins, thermosetting resins and photocurable resins.

Examples of thermoplastic resins include polyethylene, polypropylene, polyvinyl alcohol, polyvinylidene chloride, polyethylene terephthalate (PET), polyvinyl chloride, polystyrene, ABS resin, acrylic resin, polyamide, polyacetal, polybutylene terephthalate, glass-reinforced polyethylene terephthalate, polycarbonate, modified polyphenylene ether, polyphenylene sulfide, polyether ether ketone, liquid crystal polymer, fluorine resin, polyarylate, polysulfone, polyether sulfone, polyamide-imide, polyether imide, thermoplastic polyimide and acrylonitrile, and these materials can be used alone or as a mixture or multilayer laminate of two or more types.

Examples of thermosetting resins include phenol resin, melamine resin, urea resin, epoxy resin, unsaturated polyester resin, polyimide resin, silicone resin, diallyl phthalate resin and polyurethane resin, and these materials can be used alone or as a mixture or multilayer laminate of two or more types.

Examples of photocurable resins include ultraviolet-curable urethane acrylate resin, ultraviolet-curable epoxy acrylate resin and ultraviolet-curable polyester acrylate resin, and these materials can be used alone or as a mixture or multilayer laminate of two or more types.

In addition, the thermoplastic resins, thermosetting resins and photocurable resins exemplified above can also be suitably used as a mixture or multilayer laminate.

In addition, in the case the resin substrate 1 is transparent with respect to visible light, a transparent resin such as polyethylene, polypropylene, polyethylene terephthalate, polyvinyl chloride, polystyrene, ABS resin, acrylic resin, polycarbonate, acrylonitrile, epoxy resin, unsaturated polyester resin, polyimide resin, silicone resin, diallyl acrylate resin, polyurethane resin, ultraviolet-curable urethane acrylate resin, ultraviolet-curable epoxy acrylate resin or ultra-violet curable polyester acrylate resin can be used in particular among the aforementioned resins.

There are no particular limitations on the shape of the resin substrate 1, and that of any arbitrary shape can be used. However, a plate-like resin substrate is preferable in terms of processing the surface 1a.

Wettability of a solid surface in terms of hydrophilicity and water repellency is evaluated based on a contact angle θ with a smooth surface. The contact angle θ refers to the angle formed between a tangent line of a liquid surface at a point where a solid and liquid make contact and the solid surface, and in the case the liquid is water, the solid surface is said to be hydrophilic in the case this angle is 90° or less and water-repellent in the case this angle exceeds 90°. Furthermore, the contact angle θ is represented in the manner of equation (1) in accordance with Young's equation. Here, γ_{SV} represents the surface tension or interface free energy between a solid and liquid of a wetting line (triple line) formed by a solid, liquid and gas, γ_{LV} represents the surface tension or interface free energy between a liquid and gas of the same wetting line (triple line), and γ_{SL} represents the surface tension or interface free energy between a solid and gas of the same wetting line (triple line).

γ_{SV}=γ_{LV} cos θ+γ_{SL} (1)

According to equation (1), in the case the liquid is water and the gas is air, the contact angle θ can be seen to be determined by γ_{SV} and γ_{SL}. Namely, this indicates that the contact angle θ becomes small in the case the surface energy of the solid is large, while the contact angle θ becomes large in the case the surface energy of the solid is small. Since inorganic materials typically have a large surface energy, they easily demonstrate hydrophilicity, and since polymeric materials have small surface energy, they tend to have difficulty in demonstrating hydrophilicity.

In the present invention, a state in which water does not aggregate even after 3 seconds, for example, when a comparatively large amount of water has been applied to the surface 1a of the molded structure M, namely a state in which a water film is maintained without interruption, is treated as having hydrophilicity. In addition, hydrophilicity in the present invention is not necessarily represented by the size of the contact angle θ formed between the end of a liquid droplet and the surface of the molded structure when a liquid droplet of several microliters has been dropped into the molded structure M of the present invention.

Here, in the case of considering wettability of a relief surface, wettability may be treated in the manner of the Cassie-Baxter model or in the manner of the Wenzel model.

In the case of the Cassie-Baxter model, the recesses of a relief structure become deeper, water is unable to reach the bottoms of the recesses by capillary action, and air remains beneath water droplets. In this case, the contact angle θ of the water droplets on the relief surface becomes larger than the contact angle θ on a flat surface. Thus, in the case of measuring the contact angle θ formed between the end of a water droplet and the surface of the molded structure M when a water droplet of several microliters has dropped onto the relief surface of the molded structure M having a fine relief structure as in the present invention, determination of the contact angle θ is treated in the manner of the Cassie-Baxter model. In real life, however, cases involving the dropping of a single water droplet having a volume of several microliters are rare, and since a large amount of water is applied to the molded structure in nearly all cases, it is difficult to accurately evaluate hydrophilicity and wettability of the surface of the molded structure by treating in the manner of the Cassie-Baxter model.

On the other hand, the Wenzel model is applied in cases in which a liquid placed on a relief structure completely contacts a solid surface thereof. This refers to a state in which there is no intervention of air as in the Cassie-Baxter model, and wettability is enhanced when actual surface area attributable to the relief structure of the surface is greater than the apparent surface area. Since surface tension refers to excess interface free energy per unit surface area, if surface area is assumed to have increased by a factor of R due to the presence of a fine relief structure, then it is necessary to multiply the surface tension of a solid and the surface tension or interface free energy or of a solid and liquid in the aforementioned equation (1) by R. A contact angle θ_{R} in this case is represented by the following equation (2).

cos θ_{R}=R(γ_{SV}−γ_{SL})/γ_{LV}=R cos θ (2)

In equation (2), since R is always a positive number greater than 1, when apparent surface area increases due to the presence of a relief structure on the surface, the hydrophilicity of a hydrophilic surface is further improved. Thus, the value of R is increased and wettability is improved by increasing the fineness of the relief structure and increasing the aspect ratio thereof.

In real life, however, when a large amount of water is applied to the surface of a molded structure, a state results in which nearly all air is driven out due to the effect of the weight of the water adhering to the surface of the molded structure. Thus, when evaluating hydrophilicity in the present invention, in the case of evaluating by using the Wenzel model, a state in which a water film is maintained without interruption is treated as having hydrophilicity.

As has been described above, by forming a relief structure in the manner of the Wenzel model, hydrophilicity can be demonstrated even in the case of a material such as a resin for which it is difficult to demonstrate hydrophilicity.

There are no particular limitations on the shape of the protrusions 2, and although the shape can be any arbitrary shape, a shape that is circular, overall or similar thereto when viewed from overhead (these shapes are collectively referred to as being “substantially circular”) is preferably in terms of carrying out molding.

In addition, although the cross-sectional shape of the protrusions 2 can be columnar, spindle-shaped or a shape similar thereto, a spindle shape is preferable in terms of carrying out molding.

The dimensions of the protrusions 2 are such that the maximum width or maximum diameter when viewed from overhead is equal to or less than the shortest wavelength of visible light, and the aspect ratio of the height to the maximum width or maximum diameter of the protrusions 2 (namely, (height of protrusions 2)/(maximum width or maximum diameter of protrusions 2)) is preferably 0.5 or more, more preferably 0.6 or more and even more preferably 0.65 or more. In addition, the center-to-center distance between the protrusions 2 (to also be referred to as pitch) is preferably 200 nm to 400 nm, more preferably 225 nm to 375 nm, and even more preferably 250 nm to 350 nm. Hydrophilicity can be demonstrated even by a resin substrate in the case of having these dimensions and pitch.

On the other hand, the dimensions of the protrusions 2 are such that the width or diameter is preferably 50 nm or more due to restrictions on the production method. A width or diameter of less than 50 nm is below the processing limit. Since the wavelength region of visible light is about 400 nm to 800 nm, the dimensions of the protrusions 2 are such that the width or diameter is preferably 50 nm to 400 nm. In addition, a pitch of less than 200 nm is below the processing limit.

On the other hand, the height of the protrusions 2 is preferably such that the aspect ratio is within the range of 0.5 to 50. If the aspect ratio exceeds 50, the molded structure cannot be separated from the mold when transferring the molded structure from the mold, thereby making this the processing limit.

The molded structure M of the present invention is able to stably demonstrated hydrophilicity over a long period of time as a result of forming a fine relief structure having protrusions 2 of the shape and pitch described above on the surface of the molded structure. If hydrophilicity is maintained in this manner, the antifogging and self-cleaning properties of the molded structure are improved.

If water is applied to the surface of the molded structure M, once a thin water film is formed and maintained, condensed water does not form individual water droplets even if humidity and steam in the air condense, and since light-scattering fogging does not occur on the surface, antifogging properties become remarkable. This is particularly effective in a high-humidity environment such as a bathroom.

Similarly, in the case of a window glass or automobile rear view mirror becomes wet with rain or splashing water, the effect is demonstrated in which scattered, obstructive water droplets are not allowed to form, thereby securing an adequate field of view.

In addition, in a bathroom, for example, both water-repellent contaminants, such as sebaceous matter and body waste from the body, soap scum or hair conditioner, and inorganic contaminants such as mineral deposits have difficulty in adhering to the surface of the molded structure, and even in the case such contaminants have become adhered, as a result of water penetrating between the surface of the molded structure and the contaminant when water is applied thereto, the contaminants are lifted from the surface and washed off, thereby demonstrating a self-cleaning effect as well.

Moreover, since the molded structure M to which the present invention is applied inhibits affects of light diffraction and refraction on the surface thereof, particularly in the case the resin substrate 1 is transparent, distinct viewing properties can be obtained without the transparency of the resin substrate 1 per se being impaired by the protrusions 2.

In order to secure transparency of the resin substrate 1 by providing the protrusions 2 on the surface 1a of the molded structure M, it is necessary to inhibit actual diffraction waves of light by maintaining the pitch of the protrusions 2 at equal to or less than the shortest wavelength of visible light. In addition, the width or diameter of the protrusions 2 is also preferably equal to or less than the shortest wavelength of visible light. Furthermore, since the wavelength region of visible light is about 400 nm to 800 nm, the maximum pitch between adjacent protrusions 2 is about 400 nm, and the maximum width or maximum diameter of the protrusions 2 is about 400 nm.

Here, actual diffraction waves generated from a relief structure maintained at equal to or less than the shortest wavelength of visible light are defined by equation (3) based on diffraction theory. Furthermore, in equation (3), D represents the lattice period, N represents a constant, λ represents wavelength, α represents incident angle, β represents emergent angle, and n represents the refractive index of the medium.

D sin α+D sin β=Nnλ (3)

It can be seen from this equation that by making the lattice period to be λ/n (wavelength/medium refractive index), the occurrence of actual diffraction waves is inhibited and transparency can be maintained. For example, in the case of using a PET (polyethylene terephthalate) plate having a refractive index of n=1.57 for the resin substrate 1, if D≦250 nm with respect to the shortest wavelength of visible light, the occurrence of actual diffraction waves is inhibited and transparency can be maintained.

There are no particular limitations on the arrangement of the protrusions 2, and can be arranged in a pattern in which a plurality of the protrusions 2 are arranged in rows at a pitch equal to or less than the shortest wavelength of visible light, such as a concentric circular pattern, spiral pattern, lattice pattern or staggered pattern. Moreover, a hydrophilic region A, where a fine relief structure to be subsequently described is formed, and a water-repellent region B, where the fine relief structure is not formed, can both be present on the surface 1a of the same resin substrate 1, and hydrophilic regions and water-repellent regions can both be present. In addition, the protrusions 2 can be formed over a portion of the surface 1a or over the entire surface thereof.

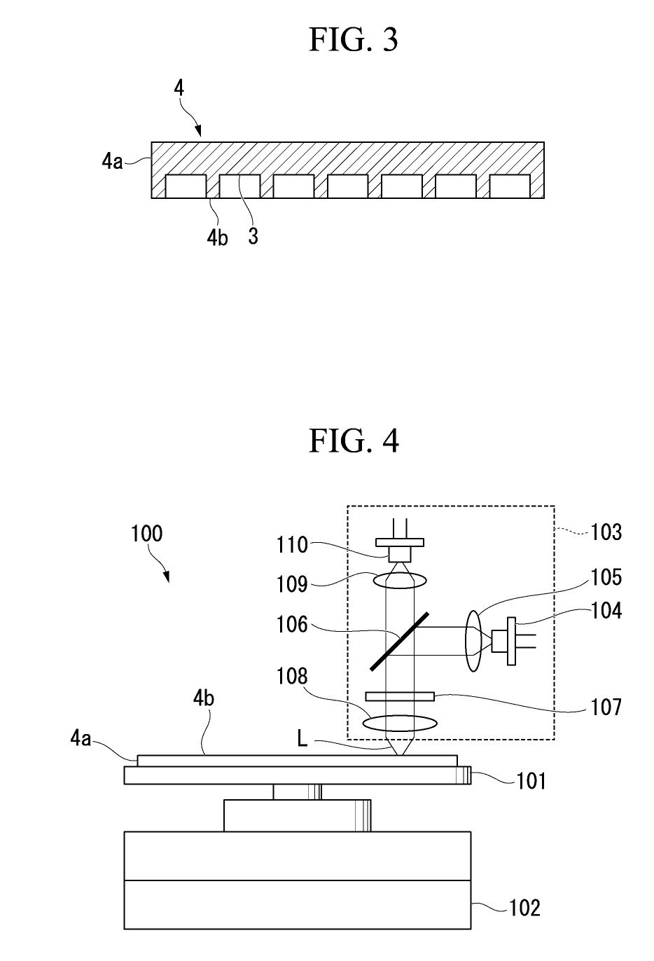

As shown in FIG. 3, a processing method can be used to form the protrusions 2 consisting of forming recesses 3, having a shape obtained by inverting the shape of desired protrusions 2, in a substrate 4a different from the resin substrate 1 to obtain a mold 4, and then transferring the shape thereof to the resin substrate 1. Although there are no particular limitations on the processing method of the mold 4, since processing involves microprocessing at the nanometer level, photolithography, electron beam lithography or thermal lithography is used preferably.

The series of processes by which a pattern is drawn in the substrate 4a using photolithography or electron beam lithography followed by forming the recesses 3 in a surface 4b of the substrate 4a by reactive ion etching (RIE) is as described below. A photosensitive resist is coated onto the surface 4b of the substrate 4a by spin coating, for example, and a photomask produced in advance by different means is superimposed thereon. The laminate is then exposed at this stage using laser light or an electron beam. In the case of photolithography, a short wavelength laser light source such as an excimer laser is used to improve transfer resolution. In the case of electron beam lithography, even higher resolution can be obtained than in the case of a method that uses laser light. In addition, although there is also the advantage of not requiring a mask due to the narrowness of the beam itself, pattern transfer is completed by carrying out exposure with this method to remove photosensitized locations. Subsequently, RIE is carried out to remove the photoresist and photomask to allow the obtaining of the mold 4 in which the desired recesses 3 have been formed.

RIE is a method whereby etching is carried out by extracting ions from plasma generated in a vacuum. When plasma is generated, chemically active radicals and ions are formed, positive ions are accelerated towards the substrate 4a having a negative potential and collide at a high speed with the substrate 4a, while radicals react with the substrate 4a and evaporate causing the substrate 4a to vaporize and enabling etching to proceed. This reaction occurs actively at locations contacted by ions (moving in a straight line), while hardly occurs at all on lateral surfaces. As a result, etching proceeds in the direction in which ions are scattered, thereby enabling etching to be carried out that faithfully reproduces the pattern.

Furthermore, although there are no particular limitations on the substrate 4a of the mold 4, a silicon substrate is used preferably in consideration of such factors as dimensional accuracy.

When forming a plurality of the recesses 3 of a shape obtained by inverting the shape of desired protrusions 2 at pitch equal to or less than the shortest wavelength of visible light on the surface 4b of the substrate 4a using thermal lithography, a nanoprocessing apparatus (molded structure production apparatus) 100 like that shown in FIG. 4, for example, is used.

This nanoprocessing apparatus 100 is provided with a rotatable rotating stage 101 that holds the substrate 4a, a moving table 102 that moves the rotating stage 101 within a plane, and an optical unit 103 that carries out drawing processing on a processing target on the rotating stage 101.

Moreover, the optical unit 103 is provided with a laser light source 104 that emits a laser light L, a collimator lens 105 that converts the laser light L emitted from the laser light source 104 to directional light, a polarizing beam splitter 106 that reflects the laser light L converted to directional light by the collimator lens 105 and transmits return laser light L that has returned after being reflected at the surface 4b of the substrate 4a, a ¼ wave plate 107 that converts linearly polarized laser light L reflected with the polarizing beam splitter 106 to circularly polarized light and converts return laser light L that has returned after being reflected from the surface 4b of the substrate 4a to linearly polarized light, an object lens 108 that concentrates laser light L that has passed through the ¼ wave plate on the surface 4b of the substrate 4a, a condenser lens 109 that concentrates laser light L that has been reflected from the surface 4b of the substrate 4a returned after passing through the ¼ wave plate 107 and the polarizing beam splitter 106, and an optical detector 110 that receives laser light L that has been concentrated by the condenser lens 109, and carries out control that aligns the focal point of the object lens 108 on the surface 4b of the substrate 4a while scanning the object lens 108 in the direction of the optical axis.

A plurality of the recesses 3 are formed at a pitch equal to or less than the shortest wavelength of visible light on the surface of the substrate 4a of the mold 4 using this nanoprocessing apparatus 100. First, a resist is coated onto the surface 4b of the substrate 4a by spin coating, and a multilayer film composed mainly of platinum oxide is formed as a thermal lithography layer by sputtering. Furthermore, although a phase-changing material that uses a single element such as germanium, antimony or terbium, an alloy composed mainly of the aforementioned materials, an oxide or a nitride, or an organic material having non-linear reactive properties with respect to temperature, can be used for the thermal lithography layer, a multilayer film composed mainly of platinum oxide eliminates the need for a developing process for forming a pattern and can also be produced with favorable reproducibility, thereby making this preferable.

After having placed the substrate 4a on the rotating table 101 while in this state, the substrate 4a is rotated by the rotating table 101 and the rotating stage 101 is moved relative thereto at a pitch equal to or less than the shortest wavelength of visible light for each rotation in the radial direction of the substrate 4a while patterning is carried out on the thermal lithography layer while driving the laser light source 104 at a fixed pulse frequency.

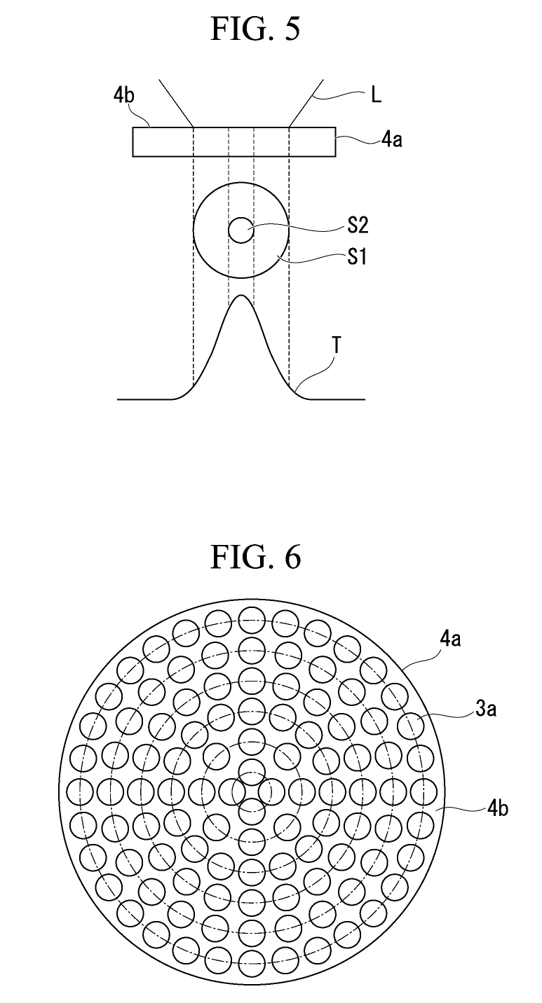

Here, in the case of thermal lithography, the temperature distribution present in the spot of the laser light L concentrated on the surface 4b of the substrate 4 is used for patterning. More specifically, as shown in FIG. 5, a spot region S1 of the laser light L concentrated on the surface 4b of the substrate 4a has a light intensity distribution T that typically has a Gaussian distribution. In addition, in the case of radiating light onto an object, optical energy is converted to heat as a result of the object absorbing the light. In this case, the temperature distribution resulting from the generation of heat caused by the object absorbing the light similarly has a Gaussian distribution. In thermal lithography, a region S2 (to be referred to as the thermal lithography region) at a fixed temperature or higher that forms within the spot S1 of this concentrated laser light L is used for processing that induces a chemical and/or physical reaction. Thus, according to this thermal lithography, pattering can be carried out by using this thermal lithography region S2 that is smaller than the spot region S1 of the laser light L radiated onto the surface 4b of the substrate 4a.

Furthermore, the temperature distribution within the spot region S1 of the laser light L as described above is dependent on such factors as the power of the laser light L and the movement speed of the substrate 4a. Thus, in order to obtain the recesses 3b of a desired shape, it goes without saying that it is necessary to suitably adjust these conditions.

As a result, as shown in FIG. 6, the thermal lithography layer is removed corresponding to the pattern drawn on the surface 4b of the substrate 4a, and a drawing pattern 3a corresponding to the recesses 3 can be formed in the photoresist in the shape of concentric circles at a pitch equal to or less than the shortest wavelength of visible light. Furthermore, in the case of forming the drawing pattern 3a in the shape of concentric circles or a spiral in this manner, processing can be carried out easily by placing the substrate 4a on the rotating stage 101 or by processing while rotating the optical unit 103 with respect to the substrate 4a. In addition, processing in this manner offers the advantage of being to shorten processing time and reduce processing costs as compared with the case of processing while moving the optical unit 103 relative to the substrate 4a in a planar direction (XY directions).

A resist pattern having openings at those locations corresponding to the recesses 3 is formed by developing the photoresist on the substrate 4a after patterning. After carrying out etching on the surface 4b of the substrate 4a on which the aforementioned pattern has been formed, a plurality of recesses 3 can be formed in the form of dots at a pitch equal to or less than the shortest wavelength of visible light on the surface 4b of the substrate 4a by removing the resist pattern.

Next, the formed mold 4 is used as a template to transfer the shape of the recesses 3 having a shape obtained by inverting the shape of desired protrusions 2 to the surface 1a of the resin substrate 1. As a result, the molded structure M can be obtained in which the protrusions 2 of a prescribed shape are formed. Furthermore, transfer from the mold 4 can be carried out by, for example, heating the mold 4 and the resin substrate 1 followed by press molding, injection molding or nanoimprinting and the like.

Nanoimprinting is a technology consisting of interposing the resin substrate 1 between the mold 4 and another substrate and transferring a nanostructure. This process is composed of coating the resin substrate 1 onto a substrate, transferring by pressing, heating or irradiating with UV light and releasing from the mold, and enables volume production at low cost using simple equipment.

For example, in the case of nanoimprinting by irradiating with UV light, a UV-curable type of photocurable resin is coated onto a material through which UV light is able to pass used as a substrate by spin coating to a uniform film thickness to obtain the resin substrate 1. Solvent is then removed by subjecting to a baking process. Next, the aforementioned mold 4 is pressed against the resin substrate 1, and after curing the resin substrate 1 by irradiating the resin substrate 1 with UV light from the substrate side, the molded structure M, in which the protrusions 2 of a prescribed shape are formed on the surface 1a of the resin substrate 1, can be formed by separating the mold 4 from the resin substrate 1. In addition, a hydrophilic molded structure may also be produced by mixing a hydrophilic inorganic material into the photocurable resin.

In addition, the substrate and the resin substrate 1 may subsequently be separated, may be left in an integrated state, or multiple layers may be laminated on the opposite side (side opposite from the side on which the protrusions 2 have been formed). Namely, there are no particular limitations on the configuration of lower layers provided the uppermost layer is an embodiment described in the present invention.

Furthermore, there are no particular limitations on the material through which UV light is able to pass provided it is a material that is transparent with respect to visible light as previously described.

As was previously described, although the shape of the recesses 3 can be transferred to the resin substrate 1 by using a silicon plate for the substrate 4a of the mold 4, forming the recesses 3 in the surface 4b, and using this for the mold 4, in consideration of the life as a template, a master can be produced by inverting from this silicon plate, and then inverting one more time from this master for use as a template.

During inversion, a method is used that allows the original shape to be precisely inverted, and an example of such a method is nickel electrocasting. Nickel electrocasting is a method for plating the master surface in a nickel sulfamate bath. An inversion product can then be obtained by peeling off this plating. Furthermore, due to the low internal stress of a nickel sulfamate coating, it is suitable for electrocasting since it is easily peeled from the substrate.

Furthermore, the present invention is not necessarily limited to the aforementioned embodiment, but rather can be modified in various ways over a range that does not deviate from the gist thereof. Furthermore, in the following explanations, the same reference symbols in the drawings are used to indicate those sites that are equivalent to those of the aforementioned molded structure, and explanations thereof are omitted.

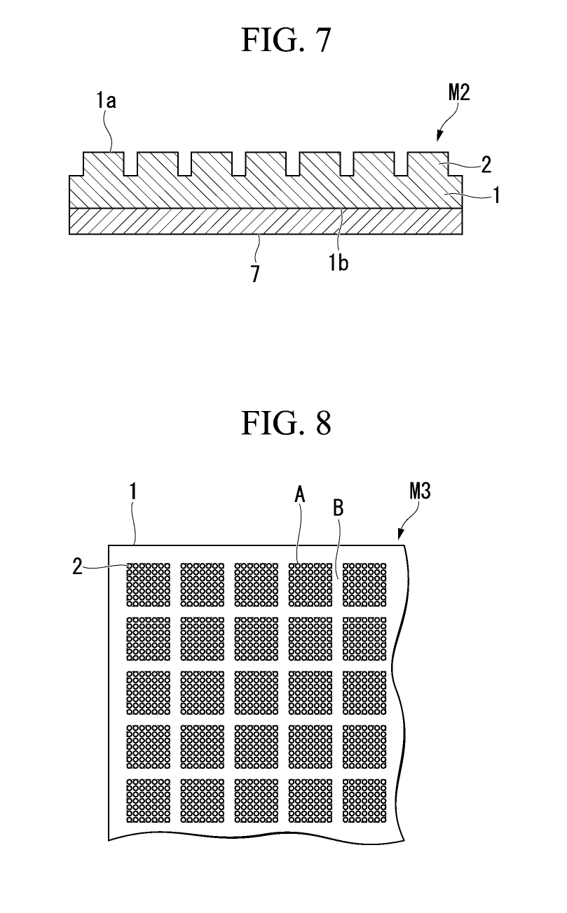

For example, as shown in FIG. 7, in another example of a molded structure M2 to which the present invention is applied, a reflective material 7 is provided on a back side 1b on the opposite side of the side on which the protrusions 2 of the resin substrate 1 are formed, thereby enabling the molded structure M2 to also function as a mirror. In addition, since this molded structure also functions as a mirror having antifogging properties, it can be preferably used, for example, as an automobile mirror or building material.

There are no particular limitations on the reflective material 7 provided it is used for a mirror. For example, the mirror production method may be a wet method or a dry method, and in the case of a wet method, silver plating is typically formed as the reflective material 7 by electroless plating. On the other hand, in the case of a dry method, a metal film such as an aluminum, chromium, platina or titanium film is formed as the reflective material 7 in a vacuum furnace, and an alloy film composed mainly of aluminum, chromium, silver, titanium, iron or platina and the like is typically formed for the reflective material 7 by depositing by sputtering or vapor deposition.

Next, an explanation is provided of a molded structure M3 as another embodiment of the present invention that has a mixture of a region A, where a fine relief structure is formed, and a region B, where the fine relief structure is not formed, present on the surface 1a of the same resin substrate 1 as shown in FIG. 8.

The region A has a fine relief structure in which protrusions are formed as previously explained and which demonstrates hydrophilicity. On the other hand, the region B has a flat shape where the fine relief structure is not formed, and since it consists of the surface per se of the resin substrate 1, demonstrates water repellency.

As a result, when a comparatively large amount of water is applied to the molded structure M3 of the present embodiment, the water spreads out over the region A that is hydrophilic, but is repelled from the region B due to its water repellency, and when the region A and the region B are made to be mutually adjacent, a water film is able to migrate from the region B to the region A, thereby enabling migration of the water film to be controlled over time such that the water film remains on the region A but does not remain on the region B.

There are no particular limitations on the shape and area of the region A and the region B provided the region A and the region B are adjacent, and the region A can be arranged in the form of islands, while the region B can be continuously arranged around the periphery of the region A while remaining adjacent thereto. In addition, the sea-island arrangement of the region A and the region B can also be reversed.

In order to control the migration of water from the region B to the region A, in the case of, for example, arranging the region A in the form of islands having a size of 0.5 mm×0.5 mm, the interval between the region A and a plurality of proximal regions A is preferably 3 mm or less (namely, the width of the region B positioned between a plurality of proximal regions A is 3 mm or less). If this interval is 3 mm or less, water can be controlled so as not to remain in the region B. In the case this interval exceeds 3 mm, although water moves from the region B to the region A, due to the excessively large interval between the regions A, water ends up remaining in the region B. Furthermore, the interval and arrangement of the region A can be suitably adjusted according to the size of the region A.

As was previously described, the molded structure M3 in which the region A and the region B are formed in this manner can be produced by transferring a mold 4 in which are formed the recesses 3 of a shape obtained by inverting the shape and arrangement of the desired protrusions 2 and the regions A and B to the resin substrate 1, and the mold 4 can use photolithography, electron beam lithography or thermal lithography. In any case, patterning is carried out corresponding to the region A and the region B.

According to the molded structure M3 of the present embodiment, by providing the region A, where a fine relief structure is formed, and the region B, where the fine relief structure is not formed, on the resin substrate 1, and using the hydrophilicity of the region A and the water repellency of the region B, a water film is allowed to migrate from the region B to the region A, thereby making it possible to control movement of the water film and allow the water film to only remain in the region A.

### EXAMPLES

The following provides greater clarification of the effects of the present invention through examples thereof. Furthermore, the present invention is not limited to the following examples, but rather can be suitably modified within a range that does not deviate from the gist thereof.

### Example 1

A molded structure to which the present invention was actually applied was produced in Example 1. More specifically, recesses were patterned on a silicon plate (Mitsubishi Materials Electronic Chemicals Co., Ltd., 5-inch diameter silicon wafer, thickness: 0.6 mm) using thermal lithography to produce a mold.

In order to accomplish this, a thermal lithography layer was first deposited using a sputtering system (Shibaura Mechatronics Corp., I-Miller). The thermal lithography layer used here consisted of a multilayer film consisting mainly of platinum oxide, and following deposition, was patterned with nanometer-size recesses using the nanoprocessing apparatus shown in FIG. 4.

Here, fine recesses equal to or less than the spot diameter of laser light were patterned in the thermal lithography layer using thermal lithography. The patterning conditions at this time consisted of laser intensity during patterning of 15 mW, rotating speed of 3 m/sec, patterning pulse width of 10 ns, and patterning frequency of 30 MHz.

Next, etching was carried out using a reactive etching system (Samco Inc., RIE-10NR) to form recesses in the surface of the silicon plate. The reactant gas used at this time consisted of CF₄, O₂ and CHF₃. Moreover, the thermal lithography layer was removed with hydrofluoric acid and the like to produce a silicon plate in which recesses were formed. The shape of the recesses formed was that of an inverted cone, the depth thereof was about 200 nm, the pitch was about 300 nm, and the maximum opening diameter was about 300 nm.

Next, in order to produce a molded structure by nanoimprinting, a photocurable resin (Toyo Gosei Co., Ltd., PAK-02) was first suitably coated onto a PET film (Teijin DuPont Films Japan Ltd., HLF175, thickness: 0.175 mm), the film was placed on a spin coater, and the film was coated to a resin thickness of 0.01 mm.

Next, the resin-coated PET film and the previously produced mold were placed in an imprinting device, and the mold was held on the resin coated side of the film at a pressing pressure of 1 MPa while irradiating the film side with UV light at an intensity of 250 W/m² for 20 seconds to cure the photocurable resin.

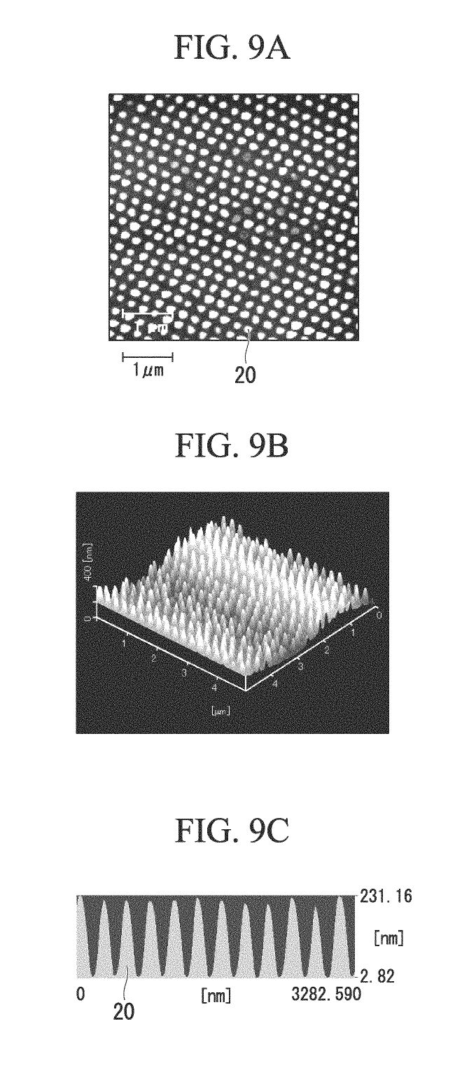

Next, the mold and film were separated to obtain a molded structure. Data obtained by measuring the surface of the substrate of a molded structure 5 of Example 1 produced in the manner described above with an AFM (atomic force microscope, SII Nano Technology Inc., Probe Station NanoNavi) is shown in FIGS. 9A to 9C. According to FIGS. 9A to 9C, the shape of protrusions 20 of the molded structure was conical, the dimensions thereof consisted of a bottom surface diameter of about 300 nm, height of about 200 nm and pitch of about 300 nm, and the aspect ratio was 0.67.

### Comparative Example 1

In Comparative Example 1, a molded structure in the form of a flat plate was produced under the same conditions as Example 1 using a silicon plate in which recesses were not formed.

### Comparative Example 2

In Comparative Example 2, a hydrophilic mirror (Honda Motor Co., Ltd., Blue Hydrophilic Mirror for Fit®) used as an automobile door mirror was provided. This hydrophilic mirror uses glass for the substrate and has a reflective material provided on one side thereof. The surface is deposited with TiO₂ and SiO₂ in that order moving from the glass side to the outside by sputtering. Since the SiO₂ is deposited in a comparatively porous form, the TiO₂ has hydrophilicity attributable to photocatalysis, while the SiO₂ maintains hydrophilicity in dark locations.

Hydrophilicity of the molded structures or Example 1 and Comparative Examples 1 and 2 was evaluated in the manner indicated below, and transparency was also evaluated for Example 1.

(Evaluation of Hydrophilicity)

Hydrophilicity was evaluated for the molded structures of Example 1 and Comparative Examples 1 and 2. Furthermore, the temperature inside the measurement room was 23±3° C. and the relative humidity was 45±10%.

Hydrophilicity was evaluated by placing the molded structures horizontally, spraying 2 cc of water over the entire surface thereof from a distance of 100 mm in several applications, placing the molded structures upright over the course of 5 seconds, calculating the manner in which the water spread out at that time in terms of the wetted surface area ratio, and evaluating the relationship between elapsed time and wetted surface area ratio. Furthermore, wetted surface area ratio refers to the ratio of the surface area wetted by water to the total surface area.

In Example 1, the wetted surface area ratio of the molded structure was 98% to 100% even after 65 days had elapsed from production thereof, and hydrophilicity was maintained over a long period of time. In Comparative Example 1, the wetted surface area ratio of the molded structure remained at 0% from the initial state thereof, thus demonstrating that the photocurable resin per se is not hydrophilic.

In Comparative Example 2, the molded structure was initially pretreated by radiating with ultraviolet light as stipulated in JIS R 1703-1. By defining the time when hydrophilicity was demonstrated as the initial state, the molded structure was subsequently stored indoors followed by evaluation of the hydrophilicity thereof.

Whereupon, the wetted surface area ratio of the molded structure after 7 days was 78%, while that after 21 days was 60%, thus indicating that hydrophilicity is inadequately sustained in dark locations, and that the molded structure to which the present invention is applied is able to better maintain hydrophilicity.

(Evaluation of Transparency)

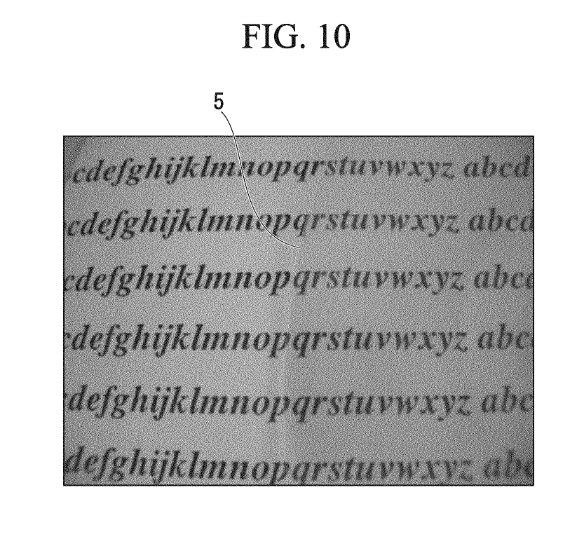

The results of confirming the transparency of the molded structure 5 of Example 1 are shown in FIG. 10. FIG. 10 is a photograph of a state in which the molded structure 5 of Example 1 is placed on a piece of paper printed with letters. It can be seen from FIG. 10 that, since the letters beneath the molded structure 5 of Example 1 can be read clearly, the transparency of the molded structure 5 of Example 1 is maintained despite having a large number of protrusions on the surface thereof.

### Example 2

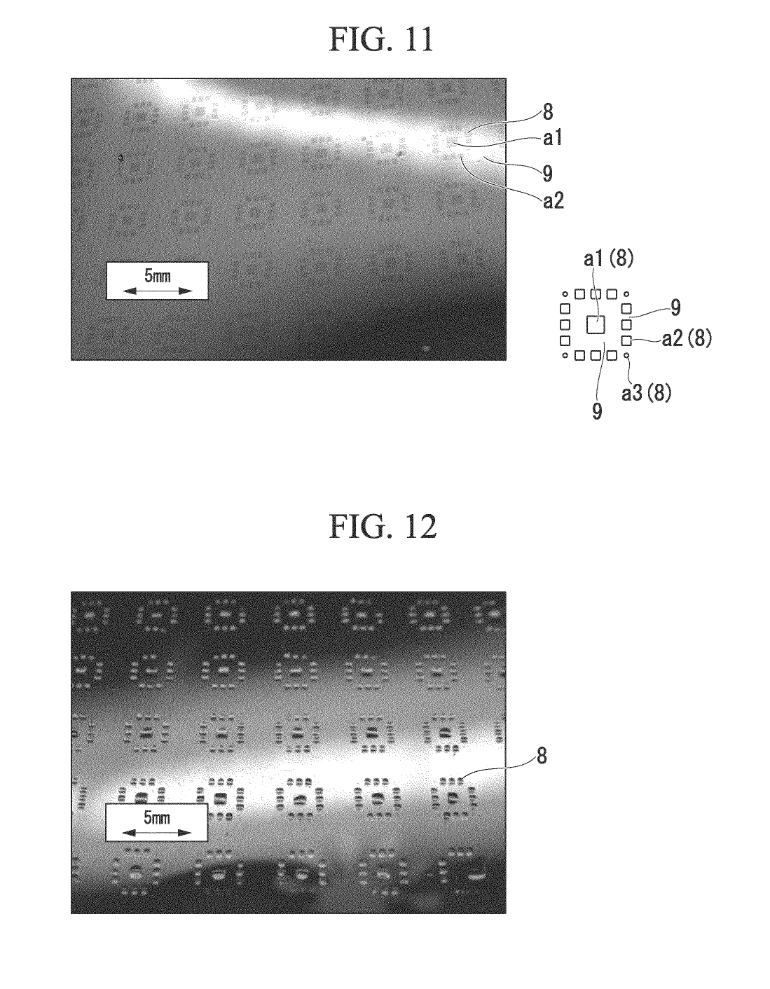

A molded structure, in which was formed regions A (regions indicated with reference symbol 8 in FIG. 11) and regions B (regions indicated with reference symbol 9 in FIG. 11) as shown in FIG. 11, was produced by thermal lithography and UV nanoimprinting.

A fine relief structure is formed in the regions A, the shape of the protrusions is conical, the bottom surface diameter is about 300 nm, the height is about 200 nm, the pitch is about 300 nm, and the aspect ratio is 0.67. The regions A consist of a plurality of a regional, having a square shape measuring 1 mm×1 mm, 12 regions a2 having a rectangular shape measuring 0.5 mm×0.6 mm formed around the regional, and 4 regions a3 having a square shape measuring 0.2 mm×0.2 mm formed between adjacent regions a2 and surrounding the regional, arranged as a single unit in the form of islands.

On the other hand, the regions B, in which the fine relief structure is not formed, are continuously present around the regions A (regional, regions a2 and regions a3), the interval between the regions B (namely, the distance between proximal regions A) is 2 mm at the widest locations and 0.2 mm at the narrowest locations.

(Movement of Water Film)

When this molded structure was leaned against a wall so as to be at an angle of 45° with respect to the ground and sprayed with 200 ml of water, nearly all of the water flowed off immediately thereafter in accordance with the incline, after which a water film that remained on the surface of the molded structure migrated from the regions B to the regions A. FIG. 12 is a photograph showing the state of the molded structure of Example 2 60 seconds after having been sprayed with water. As shown in FIG. 12, the water film remained on the regions A but did not remain on the regions B. Thus, according to the molded structure of the present invention, the migration of a water film can be controlled and a water film can be made to remain at a target location by utilizing hydrophilicity of the regions A, where a fine relief structure is formed, and the water repellency of the regions B, where the fine relief structure is not formed.

### INDUSTRIAL APPLICABILITY

According to the present invention, a molded structure can be realized that demonstrates hydrophilic, anti-fogging and self-cleaning functions over a long period of time while maintaining transparency with only a fine relief structure on a resin substrate. This molded structure can be preferably used in window materials or mirrors in, for example, architectural, industrial, automotive or solar cell panel applications.

### DESCRIPTION OF THE REFERENCE SYMBOLS

M: molded structure, 1: substrate, 2: protrusions, 3: recesses, 4: mold, 4a: substrate, 5: molded structure, 7: reflective material, 8: region A, 9: region B, 100: nanoprocessing apparatus, 101: rotating stage, 102: moving table, 103: optical unit, 104: laser light source, 105: collimator lens, 106: polarizing beam splitter, 107: ¼ wave plate, 108: object lens, 109: condenser lens, 110: optical detector, A: region A, B: region B

1. A molded structure, comprising the formation of a fine relief structure on one surface of a resin substrate that continuously prevents a water aggregation phenomenon and demonstrates hydrophilicity for forming a water film; wherein, the width or diameter of protrusions of the fine relief structure is equal to or less than the shortest wavelength of visible light, and the center-to-center distance between the protrusions is 200 nm to 400 nm, wherein a region A, where the fine relief structure is formed, and a water-repellent region B, where the fine relief structure is not formed, are formed mutually adjacent on the surface of the resin substrate, and the water film migrates from the region B to the region A.

2. The molded structure according to claim 1, wherein the aspect ratio as represented by (height of the protrusions)/(width or diameter of the protrusions) is 0.5 or more.

3. (canceled)

4. The molded structure according to claim 1, wherein the molded structure is transparent with respect to visible light.

5. The molded structure according to claim 2, wherein the molded structure is transparent with respect to visible light.
